(19) United States
(12) Patent Application Publication
(10) Pub. No.: US 2011/0238540 A1
(43) Pub. Date: Sep. 29, 2011

(54) FINANCIAL ACCOUNT MANAGEMENT BASED ON SPECIFIED CRITERIA

(75) Inventors: James Carrington, Larchmont, NY (US); Anant Nambiar, Larchmont, NY (US); Mike Rethorn, Chesterfield, MO (US); Bob Reany, Wildwood, MO (US)

(73) Assignee: MASTERCARD INTERNATIONAL, INC., Purchase, NY (US)

(21) Appl. No.: 12/732,683

(22) Filed: Mar. 26, 2010

(51) Int. Cl. G06Q 30/00; G06Q 10/00; G06Q 20/00; G06Q 40/00; G06F 17/30

(52) U.S. Cl. 705/30; 705/34; 705/40; 707/769; 707/E17.014

(57) ABSTRACT

Exemplary embodiments are directed to account management including reporting financial transactions to an account holder in a transaction reporting statement and automatic payment of open account balances. Consolidating reporting criteria and/or balance management criteria can be specified to customize reporting and/or payment of purchase transactions. The consolidated reporting criteria can be applied to transactions to identify amalgamable transactions, which can be consolidated into a consolidated transaction. The balance management criteria can include scheduling criteria and payment criteria and can be applied to open account balances to facilitate payment of open account balances.

### BACKGROUND

Non-cash transactions have become a popular method of payment for consumers. Such transactions can use transaction cards, such as credit cards or debit cards issued for accounts maintained by financial institutions, such as banks.

Credit cards allow consumers to engage in financial transactions with a participating merchant without a present requirement of money from the consumer. In a typical credit card transaction, the participating merchant receives payment from a financial institution that has agreed to allow the consumer to make purchases on credit with the promise to pay the financial institution the purchase amount plus some calculated interest at a later time. The financial institution keeps a record of the financial transactions of the consumer and sends the consumer a statement, typically monthly, that includes an itemized list of all the purchases.

Debit cards function in a similar manner as credit cards, but instead of drawing on credit, the consumer draws against money deposited with a financial institution, usually a financial institution with which the consumer has a demand deposit account. Like the statements provided for credit cards, a statement that includes debit card activity, as well as other account activity, is sent to the consumer to allow the consumer to review financial transactions during a given period. The statement can present the financial transactions associated with a debit card as a list of purchases in the same manner as the list of purchases in a credit card statement.

### SUMMARY

In one aspect, a method of managing financial transactions for an account is disclosed. The method includes traversing a computer database to identify a set of financial transactions based on an account identifier and a statement period. The financial transactions in the set include transaction information having transaction values for transaction parameters. The method also include extracting the transaction information from the computer database for the financial transactions in the set and applying consolidated reporting criteria to the transactions to identify amalgamable transactions. The method further includes consolidating the amalgamable transactions that satisfy the consolidated reporting criteria to represent the amalgamable transactions as a consolidated transaction.

In another aspect, a computer readable medium comprising instructions executable by a computing device to managing financial transactions for an account is disclosed. The execution of the instructions by the computing device generate a transaction reporting statement by traversing a computer database to identify a set of financial transactions based on an account identifier and a statement period. The financial transactions include transaction information having transaction values for transaction parameters. The execution of the instructions by the computing device generate a transaction reporting statement by extracting the transaction information from the computer database for the financial transactions in the set applying consolidated reporting criteria to the transactions to identify amalgamable transactions. The execution of the instructions by the computing device generates a transaction reporting statement by consolidating the amalgamable transactions that satisfy the consolidated reporting criteria to represent the amalgamable transactions as a consolidated transaction.

In yet another aspect, a system for managing financial transactions for an account is disclosed. The system includes computing system having one or more computing devices, wherein the computing system includes storage for storing transactions having transaction information. The transaction information includes transaction values for transaction parameters. The computing system implements a statement generator for traversing a computer database to identify a set of financial transactions based on an account identifier and a statement period. The financial transactions include transaction information having transaction values for transaction parameters. The computing system further implements a statement generator for extracting the transaction information from the computer database for the financial transactions in the set, applying consolidated reporting criteria to the transactions to identify amalgamable transactions, and consolidating the amalgamable transactions that satisfy the consolidated reporting criteria to represent the amalgamable transactions as a consolidated transaction.

Other objects and features will become apparent from the following detailed description considered in conjunction with the accompanying drawings. It is to be understood, however, that the drawings are designed as an illustration only.

### BRIEF DESCRIPTION OF THE DRAWINGS

FIG. 1 depicts an exemplary financial transaction system.

FIG. 2 is a block diagram of an exemplary account management unit.

FIG. 3 is a block diagram of an exemplary financial institution terminal.

FIG. 4 is an exemplary screen shot of a graphical user interface for specifying consolidated reporting criteria.

FIG. 5 is an exemplary flowchart that illustrates automatic payment of an account balance in accordance with balance management criteria.

FIG. 6 is an exemplary consolidated transaction reporting statement.

FIG. 7 is a flow chart that illustrates generating a consolidated transaction reporting statement.

FIG. 8 is a flowchart illustrating an exemplary implementation of consolidated reporting criteria.

FIG. 9 is a flowchart illustrating automatic payment of an open account balance using the payment generator.

### DETAILED DESCRIPTION

Exemplary embodiments include an account management unit implementing a statement generator for generating configurable consolidated transaction reporting statements and/or a payment generator for paying account balances according to balance management criteria. Embodiments of the statement generator can implement consolidated reporting criteria to identify individually authorized, post-processed amalgamable transactions from a general transaction database for incorporation in a consolidated transaction. The consolidated reporting criteria can be configurable to implement a multi-step consolidation process for consolidating the amalgamable transactions. Embodiments of the payment generator allows an account holder having a credit line to manage their account balances by scheduling periodic payment of the account balance using one or more identified accounts.

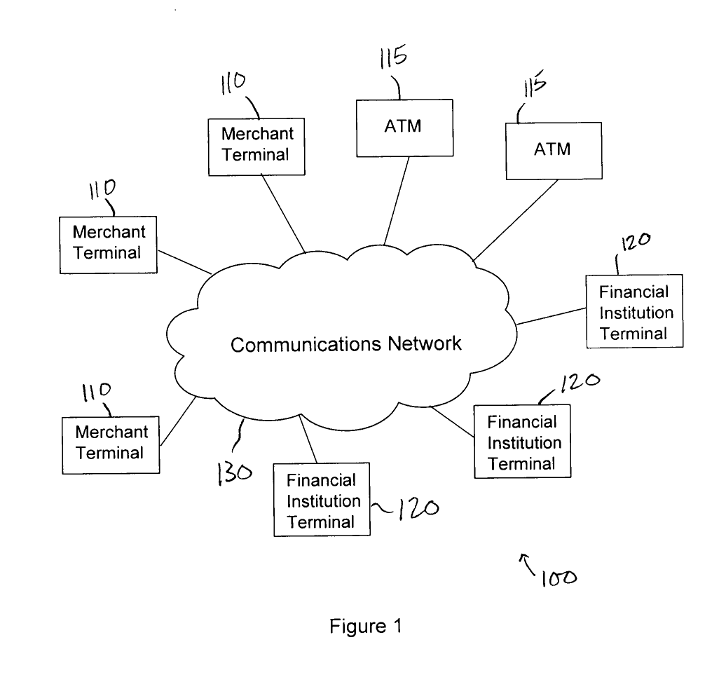

FIG. 1 depicts a financial transaction system 100 that includes merchant terminals 110, Automated Teller Machine (ATM) terminals 115 (hereinafter “ATMs 115”), one or more financial institution terminals 120, and communication network 130, such as a payment network, a public switched telephone network (PSTN), virtual private network (VPN), Internet, and the like. The merchant terminals 110 can represent devices that read account information from a customer's transaction card. Merchants that use the merchant terminals 110 may, for example, sell goods or services. The merchant terminals 110 can be dispersed throughout the world according to the geographic location(s) of the merchants.

The ATMs 115 can be geographically distributed electronic devices that dispense cash and/or accept funds for deposit into accounts. The ATMs 115 can also allow a user to view account information, such as an account balance and/or a transaction reporting statement.

The one or more financial terminals 120 can receive, collect, and maintain account information associated with account holders. Such information can include, but is not limited to an account number, a credit limit, an amount of money due, a spend amount, a deposited amount, an address of the account holder, transaction information for purchase made by the account holder. The financial institution terminals 120 can use this information when determining, for example, whether to authorize payment for the goods or services that the account holder wishes to purchase.

In a financial transaction, the account holder/customer can purchase an item from a merchant. The merchant obtains account information from the account holder's transaction card using the merchant terminal 110. The account information and transaction information are transmitted to the financial institution terminal 120, via the network 130 for authorization of the transaction. The account holder is either billed for the purchase in his next statement or funds from the account holder's account are disbursed depending on whether a credit card or debit card was used for the purchase.

The financial terminal 120 collects the transaction information associated with the purchase and stores the transaction information locally and/or remotely. The transaction information can include transaction values for transaction parameters. The transaction parameter can include a transaction size, date, time, location, merchant identifier, merchant category, an item identifier, and the like. The transaction values can include a purchase amount, a purchase date, a purchase time, a purchase location, a merchant name, a purchase type, an item description, and the like. Each transaction value can be mapped to at least one of the transaction parameters, where mapping can refer to associating and/or logically conning the transaction values with the transaction parameters such that the transaction values can be indexed using the transaction parameters. For example, the purchase amount can be mapped to the transaction size parameter, the purchase date, time, and location can be mapped to the date, time, and location parameters, respectively, the merchant name and purchase type can be mapped to the merchant identifier and the merchant category, respectively, and the item description can be mapped to the item identifier.

The financial institution can use an account management unit to implement a statement generator to generate a transaction reporting statement, based on the transaction information and the account information, to be transmitted to the account holder and/or can implement a payment generator to schedule and pay open account balances at scheduled periods. An “open account balance” refers to a balance amount that is outstanding and for which payment is expected. The one or more financial terminals can be implemented in a central or distributed manner such that the transaction information and/or account information can be in different locations. The generated transaction reporting statements can include an itemized list of transactions (e.g., purchases) for each account. The itemized list can include consolidated transactions in place of a group of independently authorized transactions satisfying consolidated reporting criteria.

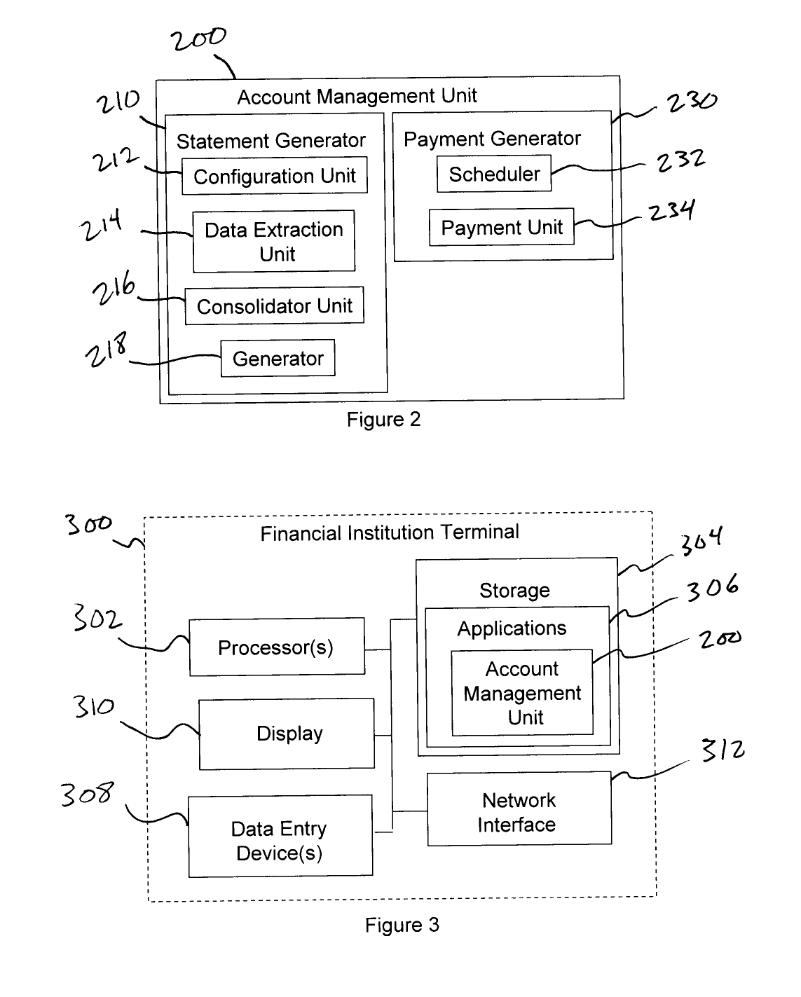

FIG. 2 is a block diagram of an account management unit 200 including a statement generator 210 that can be implemented to facilitate consolidated transaction reporting statements and a payment generator 230 to facilitate scheduled payments of open account balances. The account management unit 200, including the statement generator 210 and the payment generator 230, can be implemented using programming languages known to those skilled in the art that when executed can generate the consolidated transaction reporting statements and can facilitate automatic payment of an open account balance. The code can be composed of at least one of C, C++, Java, Basic, Perl, assembly language, machine code, and the like.

The statement generator 210 can include a consolidated reporting criteria configuration unit 212 (hereinafter “configuration unit 212”), a data extraction unit 214, a consolidator unit 216, and a generator 218. The statement generator 210 generates transaction reporting statements using consolidated reporting criteria so that consolidated transactions can be used in place of the transactions satisfying the consolidated reporting criteria.

The configuration unit 212 can be used to configure the consolidated reporting criteria. In some embodiments, the configuration unit 212 can allow a card holder to customize the consolidated reporting criteria. In some embodiments, the configuration unit 212 can allow the financial institution that issued the transaction card to specify the consolidated reporting criteria. The consolidated reporting criteria can be used to determine which of the independently authorized transactions can be replaced using a consolidated transaction. The consolidated reporting criteria can facilitate a multi-step transaction consolidation. For example, the consolidated reporting criteria can include one or more conditional requirements to be satisfied before a transaction can be included in a consolidated transaction.

The data extraction unit 214 can be configured extract transaction information associated with independently authorized transactions from a database for an account associated with an account holder. The data extraction unit 214 can query the database using an account identifier, such as an account number, a card number, and/or an account holder name. In response to the query the database can return transactions matching the account identifier. The transactions can include transaction values that are mapped to transaction parameters, which can be used by the statement generator when generating a consolidated transaction. The query can be limited to a statement period such that only the transactions that occurred during the statement period are retrieved.

The consolidator unit 216 can interface with the data extraction unit 214 to receive the transactions extracted from the database. The consolidator unit 216 applies the consolidated reporting criteria, specified by the configuration unit 212, to the transactions extracted by the data extraction unit 214 to identify transactions that satisfy the consolidated reporting criteria. The consolidator unit 216 can implement a multi-step consolidation process based on the specified consolidated reporting criteria. Transactions satisfying the consolidated reporting criteria can be separated from the remaining transactions and the consolidator unit 216 can consolidate the transactions satisfying the consolidated reporting criteria. A transaction satisfying the consolidated reporting criteria that can be included in a consolidated transaction is referred to herein as an “amalgamable transaction”.

To consolidate the transactions, the consolidator unit 216 can calculate an aggregated purchase price using the sum of the purchase prices of the independently authorized amalgamable transactions. Transaction parameters for the consolidated transaction include common transaction parameters among the transactions included in the consolidated transaction. Transaction parameters that are not shared by the amalgamable transactions included in the consolidated transaction are omitted from the transaction parameters of the consolidated transaction. In this manner, transaction parameters of a consolidated transaction may not represent a complete set of transaction parameters associated with the amalgamable transaction included in the consolidated transaction.

The generator 218 generates a consolidated transaction reporting statement including an itemized listing of the transactions extracted by the extraction unit 214 and replaces the transactions that satisfy the consolidated reporting criteria (e.g., amalgamable transactions) with a consolidated transaction such that the transactions are not listed and/or individually identifiable on the transaction reporting statement. In some embodiments, the generator 218 can transmit the transaction reporting statement to the account holder via e-mail and/or can print a copy of the transaction reporting statement on one or more sheets of paper, which can be sent to the account holder via the mail.

The payment generator 230 can include a scheduler 232 and a payment unit 234. The payment generator 230 can be used schedule and automatically pay account balances associate with a user's account (e.g., credit card account). The payment generator 230 schedule recurring payments based on user-specified balance management criteria, including scheduling criteria and/or payment criteria, so that the payment generator is configured to pay account balance at specified periods. In this manner, account balances can be paid, in-part or in-full, automatically according to the balance management criteria. The balance management criteria can facilitate a multi-step payment plan. For example, the balance management criteria can include one or more conditional requirements to be satisfied before payment of an open account balance can be automatically paid.

The scheduler 232 can facilitate scheduling of payments for accounts at a specified period using scheduling criteria. For example, the scheduler 232 can allow an account holder to specify that the account balance is to be automatically paid in-full, or in-part, on the last day of every month, on the first day of every month, every two week, every week, every day, and the like. The scheduler 232 can also allow a user to manage account balances so that the account holder's open balance never exceeds a specified value. To this end, the scheduler 232 can also allow a user to setup conditional payment plans. For example, the user can specify that the open balance of an account should be paid every two week if the account balance is over a specified amount (e.g., a dollar amount), and to pay the open balance at the end of the month if the open balance is less than the specified value. In this manner, the user can control when and under what conditions open account balances should be paid. The payment of the open balance, or a portion of the open balance, can be reported to the account holder using the transaction reporting statement generated by the statement generator. Likewise, a remaining open balance, if one exists, can be included on the transaction reporting statement.

The payment unit 234 allows an account holder to specify one or more accounts that can be used to pay the balance of the account of interest using payment criteria. For example, the account holder can identify one account to use if the account balance is less than a specified value and can identify a second account to use if the account balance is over a specified value. Likewise, the payment unit 234 can be configured to pay for transactions having a first specified merchant category with a first account and to pay for transactions having a second specified merchant category with a second account. The payment unit 234 can also split payment of the open balance across multiple accounts. For example, the payment unit 234 can be divide the account balance across three accounts so that each of the accounts used for payment can pay a portion (e.g., an equal portion) of the open account balance.

FIG. 3 depicts an exemplary financial institution terminal 300 with which the account management unit 200, or portions thereof, can be implemented. The financial institution terminal 300 can be a mainframe, personal computer (PC), laptop computer, workstation, handheld device, such as a PDA, or the like. In the illustrated embodiment, the financial institution terminal 300 includes one or more controllers or processors 302 (hereinafter “processors 302”), such as central processing unit (CPU), and storage 304 for storing data, such as transaction information, account information, transaction reporting statements, consolidated reporting criteria, and the like, as well as instructions, such as instructions for facilitating generation of transaction reporting statements. The storage 304 can include computer readable medium technologies, such as a floppy drive, hard drive, tape drive, Flash drive, optical drive, read only memory (ROM), random access memory (RAM), and the like. The storage 304 can be local or remote to the financial institution terminal 300.

Applications 306, such as the account management unit 200, the statement generator 210 for generating consolidated transaction reporting statements, and/or the payment generator 230, can be resident in the storage 304. The processors 302 can operate to run the applications (e.g., the account management unit 200, the statement generator 210, and/or the payment generator) in storage 304 by executing instructions therein and storing data resulting from the performed instructions. For example, the processors 302 can execute instructions included in the statement generator to facilitate generation of a transaction reporting statement containing one or more consolidated transactions and/or can implement instruction included in the payment generator to facilitate payment of an open account balance.

The financial institution terminal 300 can include data entry device(s) 308, such as a keyboard, touch screen, and/or mouse for allowing interaction with the financial institution terminal and a display 310 for displaying information to a user. The financial institution terminal 300 also includes a network interface 312 for communicating with a network and can be used for a distributed implementation.

In some embodiments, account management unit, the statement generator, and/or the payment generator can be implemented in a distributed manner. As one example, the statement generator and the payment generator can be implemented using different financial institution terminals. As another example, the configuration unit of the statement generator can be implemented using a first financial institution terminal, the consolidation unit of the statement generator can be implemented using a second financial institution terminal, and/or the generator of the statement generator can be implemented using a third financial institution terminal. The transaction information, account information, transaction reporting statements, consolidated reporting criteria, balance management criteria, accounts for payment of open balances, and the like, can be stored in one or more repository/database devices accessible by the financial institution terminals.

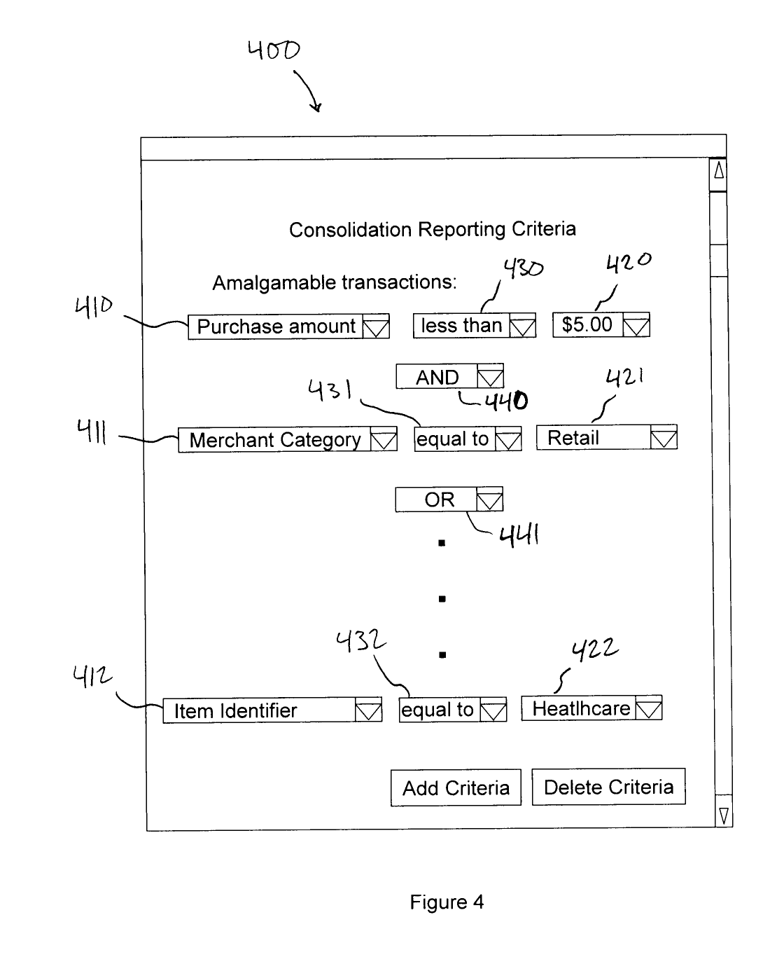

FIG. 4 is an exemplary screenshot depicting a graphical user interface (GUI) 400 that can be provided by the configuration unit of the statement generator. The GUI 400 can include data entry fields for specifying consolidated reporting criteria. Data entry fields 410-412 allow a user to select a transaction parameter. In the present example, the transaction parameter “purchase amount” has been selected for the data entry field 410, the transaction parameter “merchant category” has been selected for the data entry field 411, and the transaction parameter “item identifier” has been selected for the data entry field 412. The data entry fields 410-412 allow a user to specify the transaction parameters to be used when applying the consolidated reporting criteria.

Data entry fields 420-422 allow a user to specify transaction values to associate with the transaction parameters selected in the data entry fields 410-412, respectively. The transaction values entered in the data entry fields can correspond to the transaction parameters such that the available transaction values to choose from are limited to valid transaction values. For example, when the transaction parameter “purchase amount” is selected, the transaction values that are available can be monetary values, and when the transaction parameter “merchant category” is selected, the transaction values can be limited to defined merchant categories, such as “Retail”, “Restaurant”, “Gas”, “Entertainment”, and the like.

Data entry fields 430-432 allow users to specify conditions to be satisfied for the transaction parameters selected in the data entry fields 410-412, respectively. Some examples of condition that can be selected include “equal to”, “not equal to”, “greater than”, “greater than or equal to”, “less than”, “less than or equal to”, “within the range of”, “outside the range of”, and the like. The conditions can be used by the statement generator to define consolidated reporting criteria and to determine if a transaction satisfies the criteria. For example, criteria can be specified such that a transaction parameter associated with a transaction must have a transaction value that is less than a transaction value specified in the consolidated reporting criteria. This can be illustrated by the data entry fields 410, 420, and 430.

Data entry fields 440-441 can be used to form combinations of criteria to facilitate multi-step consolidation processing using the consolidated reporting criteria. The data entry fields can include, for example, logical parameters, such as “and”, “or”, “if then”, “if and only if”, and the like. For example, in the present example, the user can require that the purchase amount be less than five dollars and that the merchant category equal “Retail”. The GUI 400 can also include buttons 450 and 455 for adding and deleting criteria.

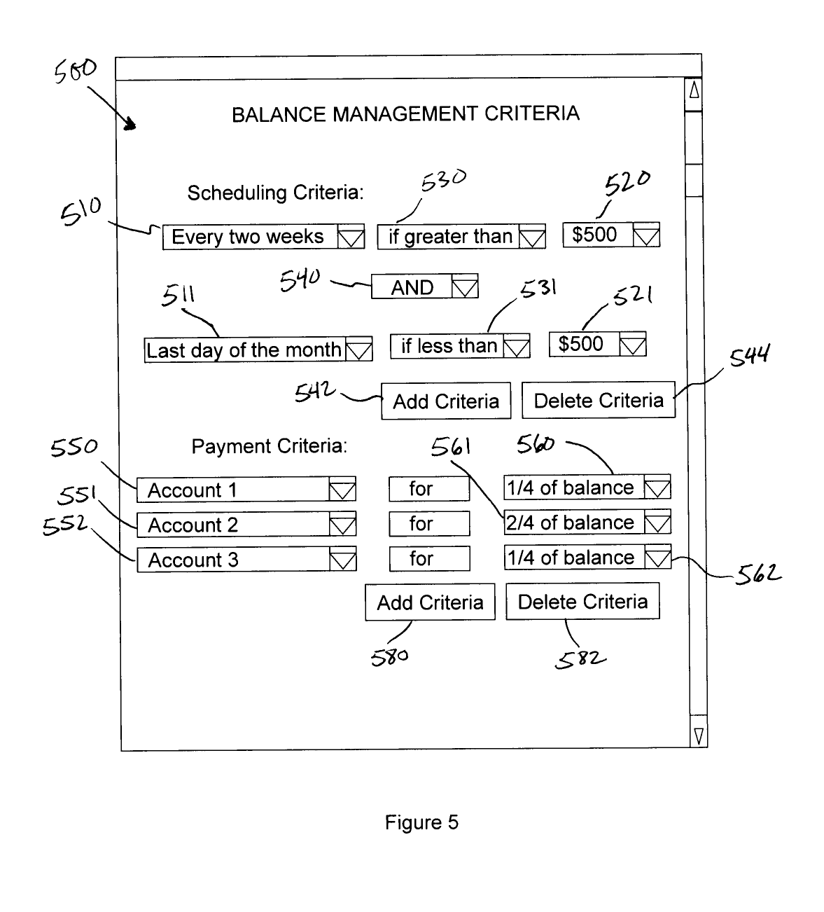

FIG. 5 is an exemplary screenshot depicting a graphical user interface (GUI) 500 that can be provided by the payment generator to facilitate specification of balance management criteria. The GUI 500 can include data entry fields for specifying the balance management criteria. Data entry fields 510 and 511 allow a user to select a periodic payment period, such as the last day of each month, the middle of every month, the first day of each month, every two weeks, every week, and the like. In the present example, the scheduling parameter “every two weeks” has been selected for the data entry field 510 and the scheduling parameter “last day of the month” has been selected for the data entry field 511. Data entry fields 520 and 521 allow a user to specify account balance values to associate with the scheduling parameters selected in the data entry fields 510 and 511, respectively. For example, the account holder can specify a dollar amount, a percentage of the open account balance, a range that the open account balance must fall within, a full amount of the open account balance, and the like.

Data entry fields 530 and 531 allow users to specify conditions to be satisfied for the scheduling parameters selected in the data entry fields 510 and 511, respectively. Some examples of condition that can be selected include “if less than”, “if greater than”, “if greater than or equal to”, “if less than, less than or equal to”, “within a percentage of”, “outside of the percentage of”, and the like. The conditions can be used by the payment generator to define an automatic payment schedule for open account balances. For example, scheduling criteria can be specified such that a scheduling parameter to pay the account balance in full every two weeks is valid if the open balance is greater than an account balance value specified in the scheduling criteria. This can be illustrated by the data entry fields 510, 520, and 530.

Data entry field 540 can be used to form combinations of scheduling criteria to facilitate multi-step scheduling using the scheduling criteria. The data entry fields can include, for example, logical parameters, such as “and”, “or”, “if then”, “if and only if”, “otherwise”, and the like. The GUI 500 can also include buttons 542 and 544 for adding and deleting scheduling criteria.

Data entry fields 550-552 allow an account holder to select a accounts from which funds can be used to pay the open account balance. In the present example, three separate accounts have been specified. Data entry fields 560-562 allow a user to specify payment terms to associate with the account parameters selected in the data entry fields 550-552, respectively. Some examples, of payment terms can include payment of a fraction or percentage of the open account balance, paying a portion of the open balance corresponding to a specific merchant category, purchase time, purchase location, and the like. The GUI 500 can also include buttons 580 and 582 for adding and deleting payment criteria.

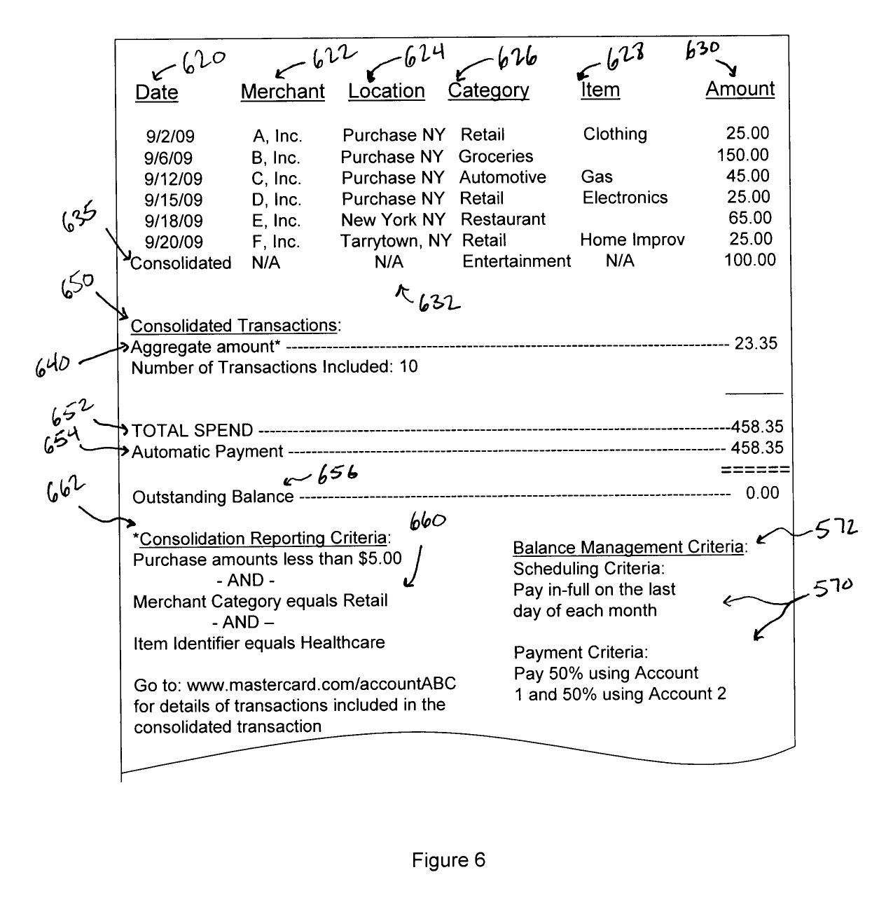

FIG. 6 is an exemplary consolidated transaction reporting statement 600 (hereinafter “statement 600”) that can be transmitted to the account holder via mail or electronic mail. The statement 600 can include a list 610 of itemized transactions, which in the present example are arranged chronologically based on the purchase date associated with the transactions. Transaction parameters, such as the date parameter 620, the merchant parameter 622, location parameter 624, the category parameter 626, item parameter 628, and the transaction size or amount parameter 630 can form columns under which the transaction values 632 for each of transactions can be inserted. In some embodiments, a consolidated transaction 635 can be included in the list 610 and the transaction values for the consolidated transaction are provided for transaction parameters defining the columns of the list, if available. In some embodiments, the term “consolidated” can be substituted for the purchase date to identify the consolidated transaction. In some embodiments, the consolidated transactions can be included in the statement 600, but can be separated from the list 610. For example, in the present example, a consolidated transaction 640 is included in the statement 600 under a consolidated transactions section 650. The purchase amounts associated with the transactions can represent a mathematical sum of the purchase amounts for the amalgamable transaction included in the consolidated transaction.

The statement can include a total spend amount 652 identifying a cumulative sum of the purchase amounts during a reporting period. The total spend amount 652 can include the consolidated transaction amount and the itemized non-amalgamable transactions. The total spend amount 652 can reduced by the automatic payment amount 654 specified by the balance management criteria to identify an open account balance 656 at the end of the reporting period.

The statement 600 can include details regarding the consolidated reporting criteria used to generate the consolidated transaction 640. For example, the consolidated reporting criteria 660 can be included in the statement 600 under a consolidated reporting section 662. In the present example, the consolidated reporting criteria 660 includes a requirement that the transactions included in the consolidated transaction are less than five dollars, are associated with the merchant category “Retail”, and include an item identifier “Healthcare”. Transactions satisfying the criteria (e.g., amalgamable transactions) are included in the consolidated transaction 640 without itemizing the transactions. In this manner, amalgamable transactions are omitted from the statement 600.

The statement 600 can also include details regarding the balance management criteria used for automatic payment. For example, the balance management criteria 670 can be included in the statement 600 under a balance management criteria section 672. In the present example, the balance management criteria 670 includes a requirement that the open account balance be paid on the last day of each month using a first account to pay fifty percent of the open balance and a second account to pay the remaining fifty percent of the open account balance.

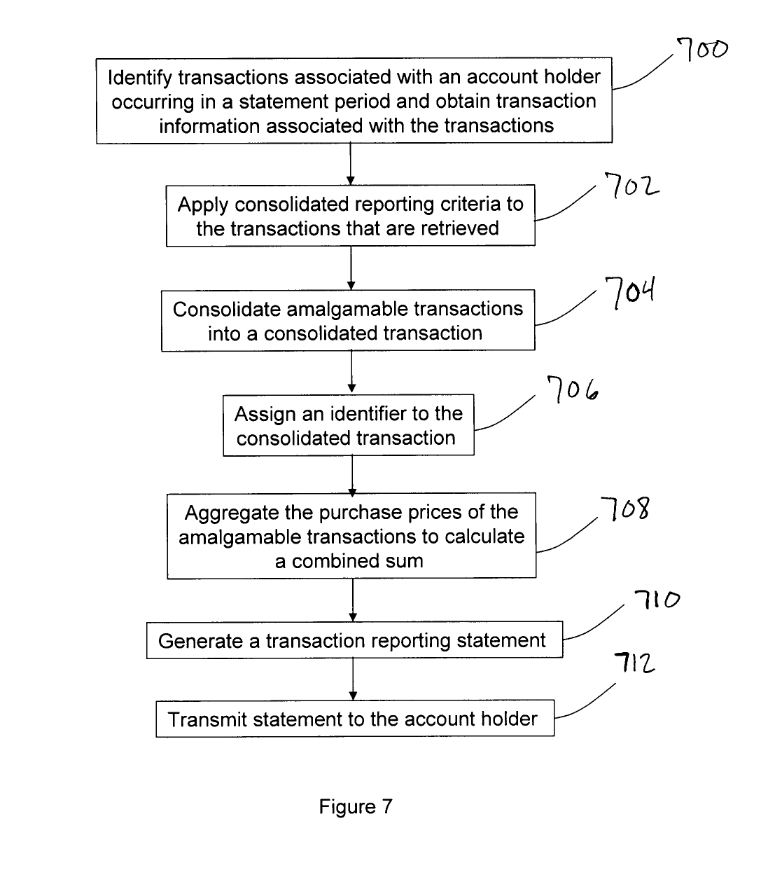

FIG. 7 is a flow chart that illustrates generating a consolidated transaction reporting statement. The statement generator identifies transactions associated with an account holder occurring in the statement period and obtains transaction information associated with the transactions (700). To achieve this, the statement generator can traverse a computer database in which the individually authorized general transactions are stored and can retrieve transactions corresponding to the account and statement period based on account identifiers and transaction dates of each transaction.

Upon extracting the general transactions associated with the account for the statement period, the statement generator can apply consolidated reporting criteria to the transactions that are retrieved (702). Initially, the statement generator can extract some or all of the transactions associated with a statement period. The transaction can be individually authorized, post-processed transactions. The consolidated reporting criteria can use a combination of logical conditions (e.g., Boolean conditions), mathematical conditions, and the like, to facilitate consolidation of transactions based on transaction values associated with the transactions.

In this manner, transactions can be consolidated using a multi-step process for which transactions have to satisfy different consolidated reporting criteria to be included in a consolidated transaction. For example, the consolidated reporting criteria can require that purchases that are less than a specified amount, are associated with a specified merchant category, and occur within a specified time period. In exemplary embodiments, the transactions are not pre-qualified for consolidation, and are not separated or distinguished in the database.

Transactions extracted and retrieved from the database satisfying the consolidated reporting criteria (e.g., amalgamable transactions) are consolidated by the statement generator into a single consolidated transaction (704). Transactions extracted and retrieved from the database that do not satisfy the consolidated reporting criteria are itemized in the transaction reporting statement. Once the transactions are consolidated, only the transaction values corresponding to the transaction parameter identified in the consolidated reporting criteria are retained for the single consolidated transaction. A consolidation identifier can be assigned to the single consolidated transaction that is formed using the statement generator (706). Transaction reporting statement can include one or more consolidated transactions. The consolidation identifiers can be associated with each of the transactions that are represented using the single consolidated transaction. The purchase price of each transaction included in the consolidated transaction can be aggregated to calculate a combined sum of the transactions (708). The combined sum of the transaction can be associated with the size of transaction parameter and the individual purchase amounts of the transactions included in the consolidated transaction are not retained in the transaction parameters of the of the consolidated transaction.

After the consolidated transaction is generated and the combined sum is calculated, a transaction reporting statement is generated by the statement generator (710) and transmitted to the account holder (712). The transaction reporting statement can include an itemized list of transactions using the consolidated transaction in place of the transactions satisfying the consolidated reporting criteria (e.g., amalgamable transactions) such that the individual amalgamable transaction are omitted from the consolidated transaction reporting statement. The transaction values for the transaction parameters retained by the consolidated transaction can be included in the transaction reporting statement and additional values associated with the consolidated transaction can be included. Some examples of additional values that can be include are a number of transaction represented by the consolidate transaction, the consolidated reporting criteria that was used to generate the consolidated transaction, an aggregate purchase price, and the like.

In this manner, details of the individual amalgamable transactions used for the consolidated transaction are not available in the transaction reporting statement. To retrieve and view the amalgamable transactions that are omitted from the consolidated transaction reporting statement, the account holder can access a secure website via a URL address, identified on the statement, using a web browser to review the amalgamable transaction consolidated into the consolidated transaction.

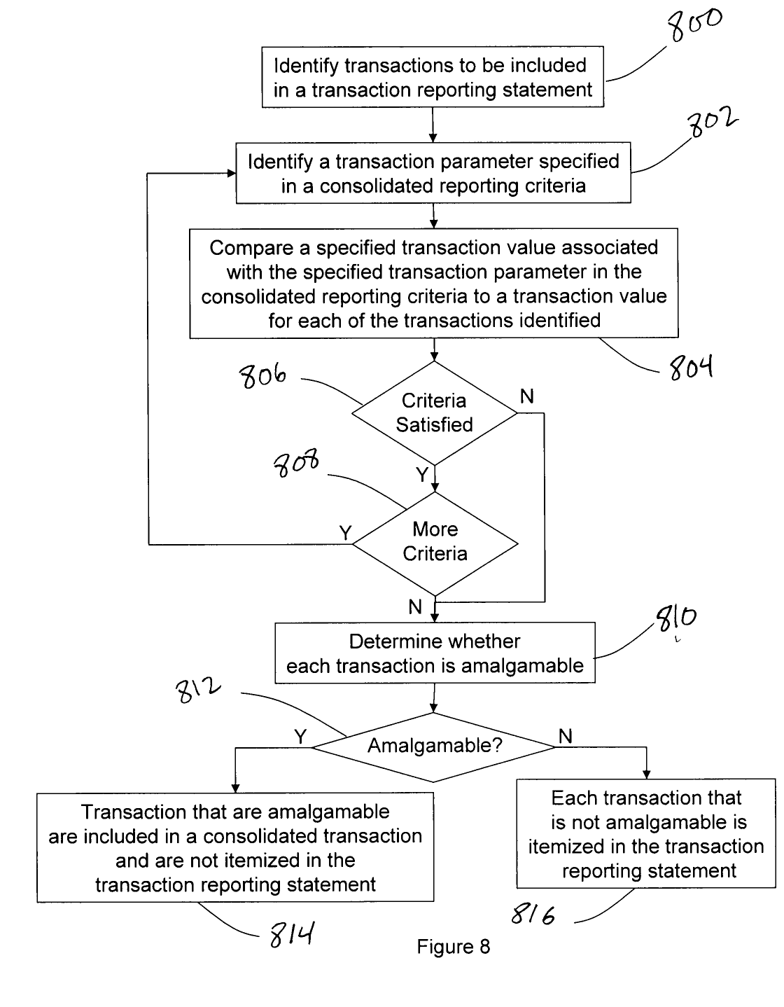

FIG. 8 is a flowchart illustrating an exemplary implementation of consolidated reporting criteria. Once the statement generator identifies transactions to be included in a transaction reporting statement (800), the statement generator identifies a transaction parameter specified in the consolidated reporting criteria (802). A transaction value corresponding to the specified transaction parameter for each of the transactions identified by the statement generator. The transaction value of each transaction is compared to a specified transaction value in the consolidated reporting criteria for the corresponding transaction parameter (804).

If the transaction value satisfies the criteria specified for the specified transaction parameter (806), the statement generator determines whether additional consolidated reporting criteria have been specified (808). If there are more criteria (808), the process repeats from step 802. If there are no more criteria (808) and/or the criteria are not satisfied (806), the statement generator determines whether the transactions are amalgamable on a transaction-by-transaction basis (810). If a transaction is determined to be an amalgamable transaction (812), the transaction is included in a consolidated transaction and is not separately itemized in the statement (814). Otherwise, the transaction is itemized in the statement (816).

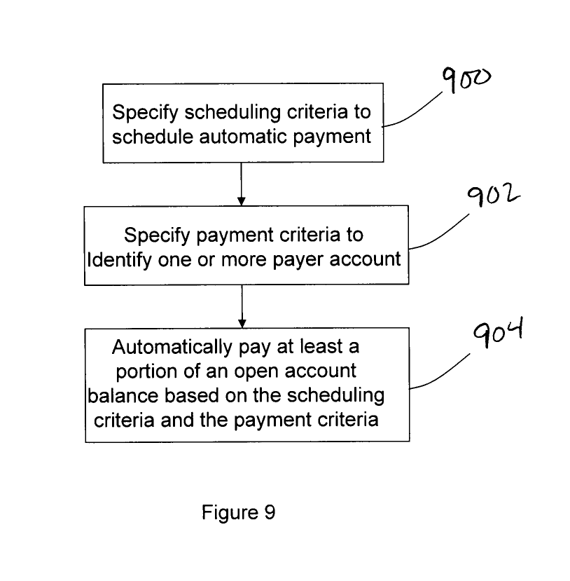

FIG. 9 is a flow chart illustrating automatic payment of an open account balance using the payment generator. Scheduling criteria to schedule automatic payment of at least a portion of an open account balance at periodic time intervals can be specified and identified (900). For example, automatic payment of the open account balance, in-full or in-part, can be scheduled to be performed monthly, bimonthly, biweekly, weekly, and the like. In addition, automatic payment can be conditionally scheduled to occur upon a trigger, such as when the open account balance is less than, greater than, less than or equal to, greater than or equal to, within a range or percent of a specified amount, and the like. Using conditional scheduling, the payment generator can perform multi-step scheduling so that the open account balance is paid based on whether the triggers are satisfied.

Payment criteria to identify a payer account to pay at least the portion of the open account balance can be specified and identified (902). For example, automatic payment of the open account balance, in-full or in-part, can be performed using one or more payer accounts. In addition, the payer accounts used to pay the open account balance can be conditioned based on a percentage or fraction of the open account balance, purchase parameters of transactions including, for example, a merchant categories, purchase locations, purchase amounts, item type, and the like. Using this approach, the payment generator can perform multi-step payment using one or more payer accounts so that the open account balance is paid in a flexible and controlled manner in accordance with the payment criteria specified by the account holder.

The open account balance, or a portion thereof, can be paid based on the scheduling criteria and the payment criteria (904). Using the payment generator, an account holder can control when and what amount of the open account balance is to be paid automatically. The multi-step features of the balance management criteria provide an account holder with a flexible schema for determining how to pay open account balances.

While exemplary embodiments have been described herein, it is expressly noted that the invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A method of managing financial transactions for an account comprising:
traversing a computer database to identify a set of financial transactions based on an account identifier and a statement period, the financial transactions including transaction information having transaction values for transaction parameters;
extracting the transaction information from the computer database for the financial transactions in the set;
applying consolidated reporting criteria to the transactions to identify amalgamable transactions; and
consolidating the amalgamable transactions that satisfy the consolidated reporting criteria to represent the amalgamable transactions as a consolidated transaction.

2. The method of claim 1, further comprising:
aggregating a purchase amount associated with the amalgamable transactions to represent a total purchase amount associated with the consolidated transaction; and
generating a transaction reporting statement including an itemized list of the transactions in the set that are not amalgamable, wherein the transaction reporting statement includes the consolidated transaction in place of the amalgamable transactions satisfying the consolidated reporting criteria.

3. The method of claim 2, wherein generating a transaction reporting statement includes identifying, in the transaction reporting statement, an amount of an open account balance for which automatic payment was performed.

4. The method of claim 3, further comprises:
identifying scheduling criteria for scheduling the automatic payment of the amount of the open account balance;
identifying payment criteria for paying the amount of the open account balance, the payment criteria including at least one payer account; and
paying the at least a portion of the open account balance based on the scheduling criteria and the payment criteria.

5. The method of claim 1, wherein the transaction parameters include at least one of a transaction size, date, time, location, merchant, merchant category, type of purchase, and an item identifier and the transaction values include at least one of a purchase amount, a purchase date, a purchase time, a purchase location, a merchant at which the purchase occurred, a purchase type, and an item description.

6. The method of claim 1, wherein applying consolidated reporting criteria comprises performing a multi-step consolidation process including a combination of consolidated reporting criteria.

7. The method of claim 6, wherein performing the multi-step consolidation process comprises:
identifying a first transaction parameter specified in the consolidated reporting criteria for a first criteria;
comparing a first transaction value specified in the consolidated reporting criteria, and corresponding to the first transaction parameter specified in the consolidated reporting criteria, to an actual transaction value associated with a first one of the transactions in the set;
determining whether the first one of the transactions in the set satisfies the first criteria in response to comparing the first transaction value to the actual transaction value;
identifying a second transaction parameter specified in the consolidated reporting criteria;
comparing a second transaction value specified in the consolidated reporting criteria, and corresponding to the second transaction parameter specified in the consolidated reporting criteria, to another actual transaction value associated with the first one of the transactions in the set;
determining whether the first one of the transactions in the set satisfies the second criteria in response to comparing the second transaction value to the other actual transaction value; and
determining whether the first one of the transactions is an amalgamable transaction based on whether the first and second criteria have been satisfied.

8. A computer readable medium comprising instructions executable by a computing device to managing financial transactions for an account by:
traversing a computer database to identify a set of financial transactions based on an account identifier and a statement period, the financial transactions including transaction information having transaction values for transaction parameters;
extracting the transaction information from the computer database for the financial transactions in the set;
applying consolidated reporting criteria to the transactions to identify amalgamable transactions; and
consolidating the amalgamable transactions that satisfy the consolidated reporting criteria to represent the amalgamable transactions as a consolidated transaction.

9. The medium of claim 8, wherein execution of instructions by the computing device generates a transaction reporting statement by:
aggregating a purchase amount associated with the amalgamable transactions to represent a total purchase amount associated with the consolidated transaction; and
generating a transaction reporting statement including an itemized list of the transactions in the set that are not amalgamable, wherein the transaction reporting statement includes the consolidated transaction in place of the amalgamable transactions satisfying the consolidated reporting criteria.

10. The medium of claim 9, wherein generating a transaction reporting statement includes identifying, in the transaction reporting statement, an amount of an open account balance for which automatic payment was performed.

11. The medium of claim 8, wherein the transaction parameters include at least one of a transaction size, date, time, location, merchant, merchant category, type of purchase, and an item identifier and the transaction values include at least one of a purchase amount, a purchase date, a purchase time, a purchase location, a merchant at which the purchase occurred, a purchase type, and an item description.

12. The medium of claim 8, wherein applying consolidated reporting criteria comprises performing a multi-step consolidation process including a combination of consolidated reporting criteria.

13. The medium of claim 12, wherein performing the multi-step consolidation process comprises:
identifying a first transaction parameter specified in the consolidated reporting criteria for a first criteria;
comparing a first transaction value specified in the consolidated reporting criteria, and corresponding to the first transaction parameter specified in the consolidated reporting criteria, to an actual transaction value associated with a first one of the transactions in the set;
determining whether the first one of the transactions in the set satisfies the first criteria in response to comparing the first transaction value to the actual transaction value;
identifying a second transaction parameter specified in the consolidated reporting criteria;
comparing a second transaction value specified in the consolidated reporting criteria, and corresponding to the second transaction parameter specified in the consolidated reporting criteria, to another actual transaction value associated with the first one of the transactions in the set;
determining whether the first one of the transactions in the set satisfies the second criteria in response to comparing the second transaction value to the other actual transaction value; and
determining whether the first one of the transactions is an amalgamable transaction based on whether the first and second criteria have been satisfied.

14. The medium of claim 8, wherein execution of instructions by the computing device generates a transaction reporting statement by:
providing a graphical user interface through which specification of the consolidated reporting criteria is received.

15. A system for managing a financial transaction for an account comprising:
a computing system having one or more computing devices, the computing system including storage for storing transactions having transaction information, the transaction information including transaction values for transaction parameters,
the computing system being configured to:
traversing a computer database to identify a set of financial transactions based on an account identifier and a statement period, the financial transactions including transaction information having transaction values for transaction parameters;
extracting the transaction information from the computer database for the financial transactions in the set;
applying consolidated reporting criteria to the transactions to identify amalgamable transactions; and
consolidating the amalgamable transactions that satisfy the consolidated reporting criteria to represent the amalgamable transactions as a consolidated transaction.

16. The system of claim 15, wherein computing system is further configured to:
aggregate a purchase amount associated with the amalgamable transactions to represent a total purchase amount associated with the consolidated transaction; and
generate a transaction reporting statement including an itemized list of the transactions in the set that are not amalgamable, wherein the transaction reporting statement includes the consolidated transaction in place of the amalgamable transactions satisfying the consolidated reporting criteria.

17. The system of claim 16, wherein computing system generates the transaction reporting statement to include an amount of an open account balance for which automatic payment was performed.

18. The system of claim 15, wherein the transaction parameters include at least one of a transaction size, date, time, location, merchant, merchant category, type of purchase, and an item identifier and the transaction values include at least one of a purchase amount, a purchase date, a purchase time, a purchase location, a merchant at which the purchase occurred, a purchase type, and an item description.

19. The system of claim 15, wherein applying consolidated reporting criteria comprises performing a multi-step consolidation process including a combination of consolidated reporting criteria.

20. The system of claim 19, wherein performing the multi-step consolidation process comprises:
identifying a first transaction parameter specified in the consolidated reporting criteria for a first criteria;
comparing a first transaction value specified in the consolidated reporting criteria, and corresponding to the first transaction parameter specified in the consolidated reporting criteria, to an actual transaction value associated with a first one of the transactions in the set;
determining whether the first one of the transactions in the set satisfies the first criteria in response to comparing the first transaction value to the actual transaction value;
identifying a second transaction parameter specified in the consolidated reporting criteria;
comparing a second transaction value specified in the consolidated reporting criteria, and corresponding to the second transaction parameter specified in the consolidated reporting criteria, to another actual transaction value associated with the first one of the transactions in the set;
determining whether the first one of the transactions in the set satisfies the second criteria in response to comparing the second transaction value to the other actual transaction value; and
determining whether the first one of the transactions is an amalgamable transaction based on whether the first and second criteria have been satisfied.
